(19) United States
(12) Patent Application Publication
(10) Pub. No.: US 2022/0089252 A1
(43) Pub. Date: Mar. 24, 2022

(54) TARPAULIN

(71) Applicant: Dirk Tillich, Bonaduz (CH)

(72) Inventor: Janos Tillich, Bonaduz (CH)

(21) Appl. No.: 17/421,780

(22) PCT Filed: Jan. 3, 2020
(86) PCT No.: PCT/EP2020/050092

§ 371 Date: Jul. 9, 2021

(30) Foreign Application Priority Data
Jan. 18, 2019 (EP) 10 2019 101 328.3

(51) Int. Cl. B63B 17/02

(52) U.S. Cl. CPC B63B 17/02

(57) ABSTRACT

The invention relates to a tarpaulin (10) with (a) a water-repellent textile or film element (14), (b) a plurality of pylons (16) that are fastened to the textile or foil element (14), and (c) at least one thread (18) which is held resiliently taut by the pylons (16).

The invention relates to a tarpaulin comprising a water-repellent textile or film element. Such tarpaulins are used in particular to cover boats, and serve to protect the boat against wind and weather influences, for example when mooring a boat to a buoy or dropping anchor. An additional aspect is that the boat should be protected from bird droppings. Birds, especially seagulls, like to sit on boats, which leads to the boat becoming soiled by bird droppings. This is unpleasant and may be harmful to health.

A range of possibilities has been conceived to prevent birds from sitting on a boat. For example, a scarecrow is known with an arm, usually horizontally, that rotates in the wind to scare off birds. The disadvantage of such a system is that the birds quickly get used to the movement and still occupy the boat.

It is also known, for example, to stretch thin metal wires on houses, which do not allow a pigeon to perch on them. Such a system is not well-suited for a tarpaulin as this requires the tarpaulin to generate the forces that are needed to stretch the wire.

DE 33 41 530 C1 discloses a scarecrow for unoccupied boats in which simple and fast handling can be achieved with cords spanning the hulls of the boats. The cords can be pulled from automatic retraction devices that can be detachably secured on the boat side, against the force of a retraction spring, and hooked with their front end in the pulling direction onto holders that can be detachably secured on the boat side.

DE 32 37 840 A1 describes a seagull protection that is characterised in that rubber cords, a lifting ring and fastening rings/fastening studs are arranged with the tarpaulin on boats and ships in such a way that it is impossible for seagulls and other birds to settle on them, thereby rendering it impossible for them to soil the decks, tarpaulins and other boat and ship parts.

DE 10 2006 004 787 A1 discloses a net composed of at least one part, the net being adapted to fit the hull of a boat, which comprises at least a first inner support element as well as at least two outer fastening elements and at least one inner fastening element. This net is used in a method for preventing birds from landing on boats.

DE 20 2010 015 431 U1 describes a device for scaring away and startling flying birds, especially seagulls, so as to prevent or reduce the soiling of ships. The device features multiple individual wires that are welded to a piston at the end and can be displaceably guided in a tube. The device comprises a fastening for a thin wire cable, at the end of which there is a loop for a handle; an end piece formed at an angle that guides the wires and is located at the top of the tube; end pieces that are pressed onto the end of the wires; and welded rings that are used for mounting on the ship.

The invention aims to propose improved an improved tarpaulin.

The invention solves the problem by way of a tarpaulin according to the preamble which comprises a plurality of pylons that are fastened to the textile or film element, and at least one, preferably elastic, thread which is held resiliently taut by the pylons.

The advantage of such a tarpaulin is that seagulls can be safely kept at bay. Surprisingly, it has been proven that birds do not dare land on a resiliently taut thread, as the slackening and the risk of getting their feathers caught in the thread scares them away. Moreover, since the thread is fastened to the pylons in a resiliently taut manner, the thread would exert a force on the bird that would be uncomfortable for it should it nevertheless sit on the thread or one of the pylons. It has been found that with a tarpaulin according to the invention, birds, in particular seagulls, can be safely kept away from a boat covered with the tarpaulin.

A further advantage of the invention is that its structure is comparatively simple. As such, according to a preferred embodiment, it is possible for the pylons to be made of plastic, meaning that their weight is low.

If the threads are made of plastic, as is the case according to a preferred embodiment, they can be reversibly, i.e. elastically, deformed. It is then possible to simply put the tarpaulin on a boat and take it off. In the case of a wire, this would mean that the wire can be plastically deformed, making it impossible to roll up the tarpaulin, for example. However, this makes it difficult to store the tarpaulin in the boat for sailing and then protect the boat again with the tarpaulin from rain and dirt.

It is beneficial if the thread is a plastic, elastic and/or rubber thread. In this case, it is possible and represents a preferred embodiment for the thread to be composed of a plurality of sub-threads, i.e. filaments. Within the scope of the present description, a thread is understood particularly to mean a flexible structure composed of fibers which exhibits a dominant one-dimensional extension and a uniformity in the longitudinal direction. However, within the scope of the present invention, a thread should also be understood to mean a flexible structure not composed of fibers, provided that the cross-section of said thread is greater than 0.2 mm. The cross-section is preferably smaller than 10 mm. For example, a structure, for example a nylon structure, with a diameter of at least 0.2 mm that is flexible and exhibits a dominant one-dimensional extension and a uniformity in the longitudinal direction, should be understood to mean a thread within the meaning of this application. However, it is especially beneficial if the thread is composed of multiple elementary fibers.

The thread is preferably elastic. For example, it is possible that the thread is composed of material that exhibits entropic elasticity.

According to a preferred embodiment, the pylons are arranged and fastened to the textile or film element in such a way that a deflection of the thread centrally between two pylons is at least 0.003 meters per newton under a vertically acting force. In particular, the deflection is at least 1 centimeter per the weight force, which corresponds to 300 g. In other words, the thread moves by at least 1 centimeter if a seagull with a weight of 300 g settles on the thread. Preferably, the spring constant is at least twice as high. Since the seagull cannot find a foothold on the thread, it perceives the place as an unattractive landing site, which it avoids. It is beneficial if the deflection is at most 0.3 meters with a weight force that corresponds to 100 g.

It is beneficial for the pylons to be arranged in such a way that a maximum distance between two threads and/or a maximum distance between two thread sections of the same thread is a maximum of 60 centimeters. It has been found that seagulls do not land on a tarpaulin with these properties.

It is beneficial if the height at which the thread is attached to the pylon is at least 5 centimeters, preferably at least 15 centimeters. To take off and land, birds needs a clear area below the wings to be able to generate a backward force with their wings immediately before touchdown. If the pylons are at the height stated and the threads/thread sections are at a sufficiently small distance from one another as described above, a bird cannot land without a wing touching a thread during its landing approach, which is very uncomfortable for the bird. Therefore, birds do not approach this kind of tarpaulin.

Preferably, the at least one pylon has a fastening structure for fastening the at least one first thread and at least one hole for fastening a second thread, wherein the hole is at a distance of at least 2 centimeters and/or at most 15 centimeters from the fastening structure in a longitudinal direction of the pylon. In other words, two threads are arranged at a distance of at least 2 centimeters and/or at most 15 centimeters from each other on the pylon. This has the advantage that the deterrent effect on birds is further enhanced. In this way, the second thread scares off smaller birds. If the pylon is fastened close to an edge of the textile or film element and tilts away from the edge, the second thread prevents a bird from being able to sit on the resulting free space.

It is especially preferable if the at least one pylon features a second hole for fastening a third thread, wherein the first hole is arranged between the attachment structure and the second hole. A distance between the holes and/or the fastening structure and the first hole is preferably at least 2 centimeters and/or at most 15 centimeters.

It is beneficial and represents a preferred embodiment for a first thread that is fastened to the fastening structures to form a first pattern, and a second thread to extend through the first holes of the pylons and form a second pattern, which differs from the first pattern. In other words, the threads between the fastening structures on the one hand and through the first holes on the other hand do not run parallel to each other, at least in some places. This reduces the potential landing surface with a predetermined number of pylons.

It is convenient if the fastening structure has at least one slat. According to a preferred embodiment, the slats feature internal clamping teeth. It is then possible to fasten the thread to the pylon by pressing it into the clamping structure, which allows for quick assembly of the threads on the pylons and thus quick assembly of the tarpaulin. Alternatively, the fastening structure may be formed by a hole, a slit or a groove.

It is practical if each pylon features a foot and a pole, and each foot is magnetically connected to a pole. Alternatively or additionally, it is possible for each foot or each pole to be integrally bonded, especially by means of an adhesive bond, to the tarpaulin. The primary function of a tarpaulin is to keep water away from the boat's superstructure. While it is possible and represents a preferred embodiment of the invention for the foot and the pole to be connected by way of a positive-locking or frictional connection, this requires that the tarpaulin be penetrated at the point where the pylon is to be placed. This can, at least theoretically, cause the tarpaulin to leak. At the very least, there may be a concern that the tarpaulin could be damaged by assembling the pylons. This risk is ruled out by magnetic fastening. Modern magnets, for example ferrite or rare-earth magnets, are able to reach substantial magnetic field strengths, so that the pylons can be securely fastened.

Alternatively, it is preferable for a sealing element to be arranged between the textile/film element and the foot of the pylon. It is also preferable for a second sealing element to be arranged between the textile/film element and a foot section of the pole of the pylon.

Alternatively, it is possible to stick the pylons to the tarpaulin.

Alternatively, in a preferred embodiment, the pylon features a first velcro structure at its foot section and the textile or film element features, at least locally, a second velcro structure by means of which the foot can be fastened to the first velcro structure. It is possible that the first velcro structure is a barbed mat, a loop mat, or a mushroom head structure mat. It is also possible that the first velcro structure is a barbed mat, a loop mat, or a mushroom head structure mat in some sections, and another of the specified structures in other sections.

To prevent the magnets from sticking to each other when removing and storing the tarpaulin in a compact storage arrangement, and to avoid a difficult unfolding from the storage arrangement, a preferred embodiment stipulates that each foot comprises a magnet and a cover, and all magnets have the same magnetic orientation relative to the cover. Two magnetic poles with opposite poles, for example a north pole and a south pole, are thus always located at a distance that corresponds to one thickness of the cover. It is beneficial if the cover has a thickness of at least 3 mm. Preferably, the cover is made of plastic, which prevents the boat underneath from being scratched.

In the following, the invention will be explained in more detail by way of the attached figures. They show:

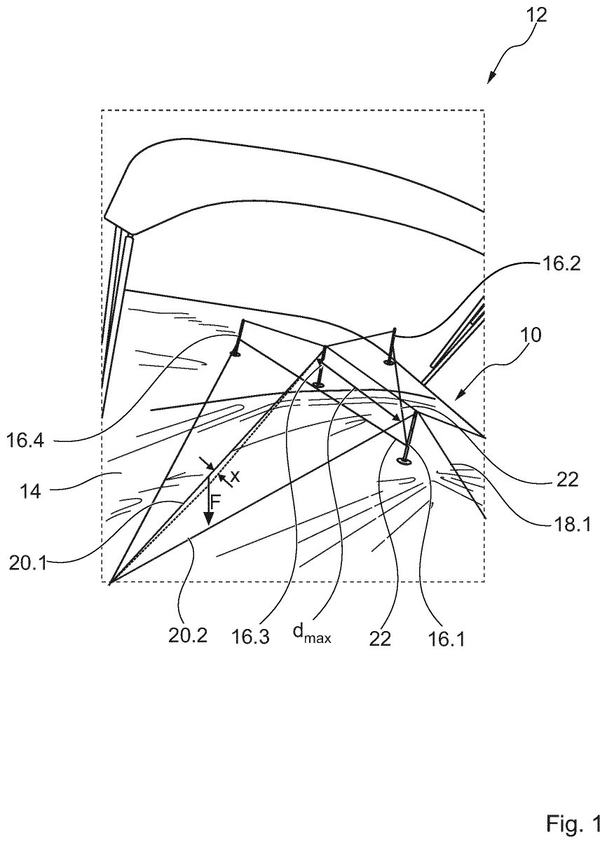

FIG. 1 a perspective partial view of a boat according to the invention with a tarpaulin according to the invention, and

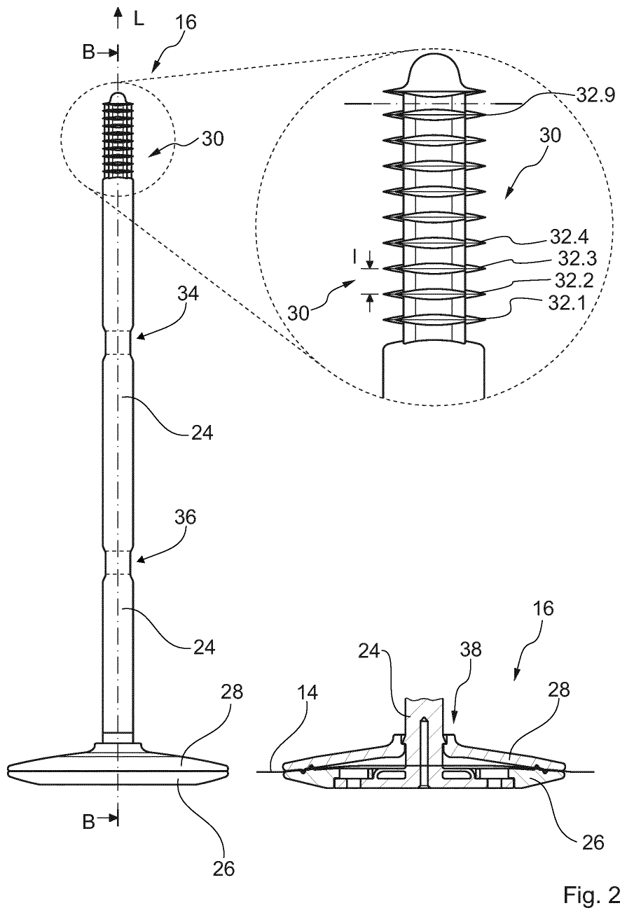

FIG. 2 a pylon of the tarpaulin according to FIG. 1.

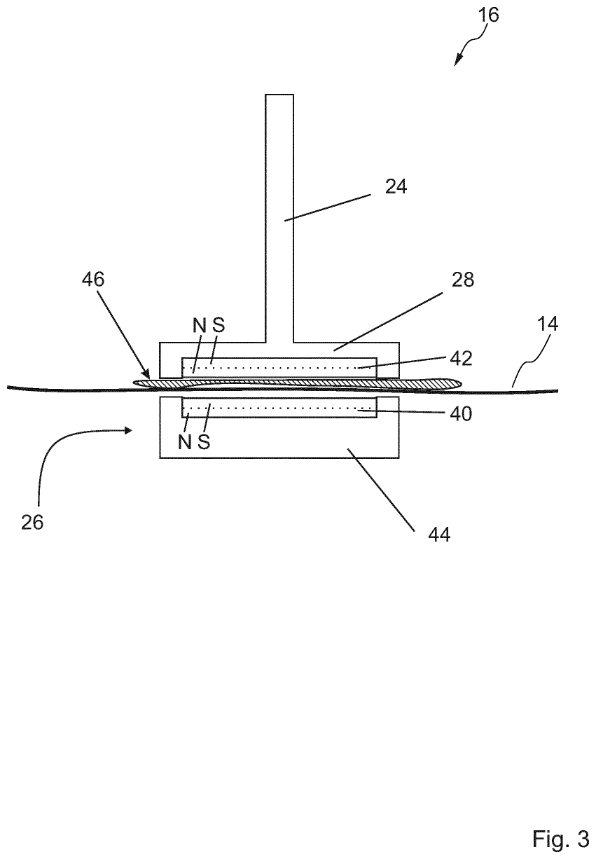

FIG. 3 depicts an embodiment of the pylon where the foot is magnetically fastened to the pole.

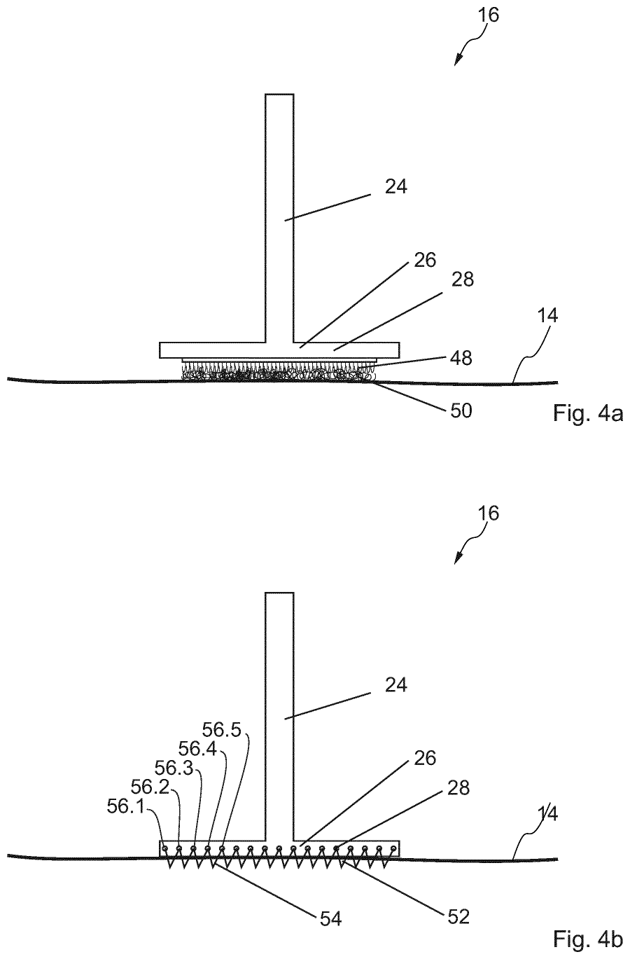

FIG. 4a depicts an alternative embodiment of the pylon where the foot is fastened to the pole by way of velcro connection,

FIG. 4a depicts a further alternative embodiment of the pylon where the foot is stitched onto the textile or film element,

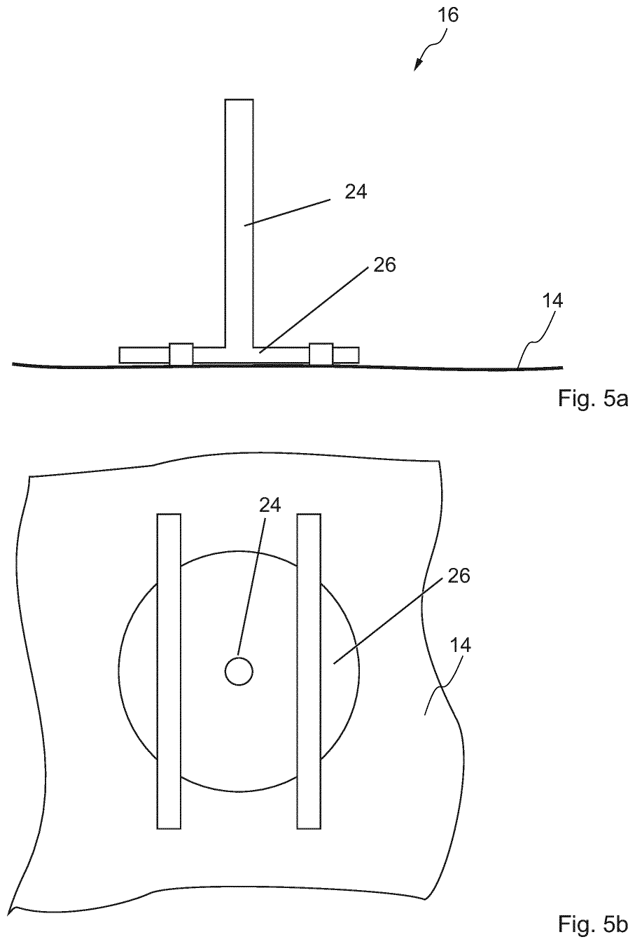

FIG. 5a depicts a further alternative embodiment of the pylon where the foot is fastened to the textile or film element by means of textile strips, and

FIG. 5b a view from above of the embodiment according to FIG. 5a.

FIG. 1 shows a tarpaulin 10 according to the invention on a boat 12 according to the invention. The tarpaulin 10 has a—preferably water-repellent—textile or film element 14, which can be, for example, a plastic, preferably a fiber-reinforced plastic, or a fiber-reinforced rubber.

The tarpaulin 10 also comprises a plurality of pylons 16.1, 16.2, . . . which are attached to the textile or film element 14. A thread 18.1 is resiliently taut between individual pylons 16.i (i=1, 2, 3, . . . ). The thread 18.j forms a thread section 20, for example the thread sections 20.1, 20.2, between two pylons 16.i, 16.j (i≠j). In the present case, the maximum distance dₘₐₓ between two thread sections 20.i, 20.j (i≠j), for example the thread sections 20.1, 20.2, is dₘₐₓ=50 centimeters.

FIG. 1 shows that a second thread 22 is stretched between the individual pylons 16.i. The second thread 22 forms a second pattern M2, which differs from a first pattern M1 with which the first thread 18 extends. For example, the first thread 18 extends from pylon 16.1 to pylon 16.3, but not to pylon 16.4. However, the second thread extends from the first pylon 16.1 to the fourth pylon 18.4.

The pylons 16.i are fastened to the textile or film element 14 in such a way that a force F, which acts vertically and centrally on a thread section, on thread section 20.1 in the present case, causes a deflection x of the thread 18, wherein a force of 3 newtons results in a deflection of at least x=1 centimeter. The thread section 20.1 in its deflected form is depicted by the dashed line.

FIG. 2 shows a pylon 16 (any reference without a numerical suffix refers to all relevant objects) of the tarpaulin 10 according to FIG. 1. It should be noted that the pylon 16 comprises a pole 24 and a foot 26. The foot 26 extends transversely to a longitudinal direction L of the pole 24 and along a foot section 28 of the pole 24.

The pylon 16 features a fastening structure 30. The fastening structure 30 comprises at least two, preferably at least three, in the present form multiple slats 32.1, . . . , 32.9. The slat distance I of two adjacent slats from one another is preferably between 0.5 times and 0.95 times a diameter of the thread 18 (cf. FIG. 1).

In addition, FIG. 2 shows that the pole has a first hole 34, through which the second thread 22 (cf. FIG. 1) extends. The pole also features a second hole 36 through which a thread, not depicted, can extend as an alternative or in addition to thread 22. The existence of a second or third thread represents an optional embodiment.

The distance between the fastening structure 30 on the one hand and the first hole 34 is preferably at least 2 centimeters and at most 15 centimeters. The distance between the first hole 34 and the second hole 36 is preferably also between 2 centimeters and 15 centimeters. The distance between the second hole 36 and the foot section 28 is preferably also between 2 and 15 centimeters.

The partial figure at the bottom right shows a cross-section through the pylon 16 at its foot end. It can be seen that the foot 26 is connected to the pole 34, and the foot section 28 is configured as a separate component from the pole 24 that can be connected to the pole 24 by means of a snap connector 38. In the assembled state, the textile or film element 14, depicted schematically, extends between the foot section 28 and the foot 26.

According to an alternative embodiment, shown in FIG. 3, the foot 28 is connected to the pole 24 by means of a magnet 40. In this case, the foot section 28 is preferably an integral component of the pole 24 and the foot 36 a separate component. A first magnet 40, which is a component of the foot 26, interacts with a second magnet 42 in such a way that the foot 26 is securely attached to the pole 24. The textile or film element 14 extends between the foot 26 and the pole 24.

It is especially convenient if—as shown in FIG. 3—the first magnet 40 and the second magnet 42 each face each other with only one magnetic orientation, i.e. north pole N or south pole S. It is especially convenient if all feet 26 are structurally identical such that the same magnetic orientation, for example the north pole in each case, is arranged facing away from a cover 44. The greater the thickness of the cover 44, the smaller the maximum attractive force that can exist between two feet. It is possible, but not essential, for the foot section 28 and/or the foot 26 to be additionally fastened to the textile or film element 14 by means of an adhesive or adhesive element 46. The adhesive element can simultaneously act as a sealing element and comprise foam, for example.

FIG. 4a depicts an embodiment in which the pylon 16 has a first velcro structure 48 on its foot section 28, said structure being connected to a second velcro structure 50 of the text or film element 14. In the present case, the first velcro structure 48 is a barbed mat; the second velcro structure 50 is a loop mat.

The first velcro structure 48 may be stuck to the foot section 28, for example, or integrally formed on the foot section 28. The second velcro structure 50 is, for example, stitched to, integrally formed on, or glued to the textile or film element 14.

FIG. 5a depicts a further alternative embodiment of the pylon 16, the foot 26 of which is fastened to the textile or film element by means of a seam 52. To this end, a thread 54 extends through holes 56.1, 56.2, . . . in the foot 26 and through the textile or film element 14.

FIG. 5a shows a side view of a further alternative embodiment of the pylon 16, the foot 26 of which is attached to the textile or film element 14 by means of textile strips 58.1, 58.2. The textile strips 58.1, 58.2 are, for example, stitched, glued or fastened via velcro fastener to the textile or film element 14 and extend across the foot 26.

FIG. 5b shows a view from above of the embodiment according to FIG. 5a.

### REFERENCE LIST

10 tarpaulin

12 boat

14 textile or film element

16 pylon

18 thread

20 thread section

22 second thread

24 pole

26 foot

28 foot section

32 slat

34 first hole

36 second hole

38 snap connector

40 first magnet

42 second magnet

44 cover

46 adhesive

48 first velcro structure

50 second velcro structure

52 seam

54 thread

56 hole

58 textile strips

dₘₐₓ maximum distance

M pattern

F force

L longitudinal direction

I slat distance

1. A tarpaulin, comprising:
(a) a water-repellent textile or film element,
(b) a plurality of pylons that are fastened to the textile or film element, and
(c) at least one thread which is held resiliently taut by at least some of the pylons of the plurality of pylons.

2. The tarpaulin according to claim 1, wherein the at least some pylons are arranged and fastened to the textile or film element such that a deflection of the at least one thread centrally between two pylons of the at least some pylons is at least 0.003 meters per newton under a vertically acting force.

3. The tarpaulin according to claim 1 wherein the at least one thread comprises two threads, and wherein the at least some pylons are arranged such that a maximum distance between the two threads and/or a maximum distance between two thread sections of a same thread of the at least one thread is a maximum of 60 centimeters.

4. The tarpaulin according to claim 1 wherein the at least one thread comprises a first thread and a second thread, and wherein the plurality of pylons comprises at least one pylon comprising
(a) a fastening structure for fastening the first thread thread, and
(b) a hole for fastening the second thread,
(c) wherein the hole is at a distance of at least 2 centimeters from the fastening structure in a longitudinal direction of the at least one pylon.

5. The tarpaulin according to claim 1 wherein the at least one thread comprises a first thread and a second thread, and wherein the plurality of pylons comprises at least one pylon comprising first holes and second holes, and wherein
(a) the first thread extends through the first holes of the at least one pylon and forms a first pattern, and
(b) the second thread extends through the second holes of the at least one pylon and forms a second pattern which differs from the first pattern.

6. The tarpaulin according to claim 1 further comprising a fastening structure which fastens the plurality of pylons to the textile or film element, wherein the fastening structure features at least one slat.

7. The tarpaulin according to claim 1 wherein each pylon of the plurality of pylons
(a) has a foot and a pole and
(b) the foot is magnetically connected to the pole.

8. The tarpaulin according to claim 5, wherein
(a) each foot has a magnet and a cover, and
(b) all magnets have a same magnetic orientation relative to a respective cover.

9. The tarpaulin according to claim 7 wherein the foot is integrally bonded with the textile or film element.

10. The tarpaulin according to claim 7 wherein
(a) the foot of a pylon of the plurality of pylons comprises a first velcro structure, and
(b) the textile or film element comprises a second velcro structure for fastening to the first velcro structure.

11. A boat with a tarpaulin according to claim 1.
